(19) United States
(12) Patent Application Publication
(10) Pub. No.: US 2010/0052568 A1
(43) Pub. Date: Mar. 4, 2010

(54) Light emitting diode array driver

(75) Inventor: Isaac Cohen, Dix Hills, NY (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/229,899

(22) Filed: Aug. 27, 2008

(51) Int. Cl. H05B 37/02

(52) U.S. Cl. 315/294

(57) ABSTRACT

A device and method for controlling current output to current driven loads such as active light emitting diodes (LEDs) and, more particularly, a device and method for controlling current to an array of active LED strings that are disposed in series. The device generates a square wave AC current that flows through primary windings of plural isolation transformers whose primary windings are electrically connected in series. The device includes a current regulator that produces a regulated DC current that is proportional to a current reference; a free running inverter that converts the DC current to square wave AC current; and plural isolation transformers whose secondary windings are electrically connected to LED strings.

### CROSS REFERENCE TO RELATED APPLICATIONS

(Not Applicable)

### STATEMENT REGARDING FEDERALLY SPONSORED RESEARCH OR DEVELOPMENT

(Not Applicable)

### BACKGROUND OF THE INVENTION

A device and method for controlling current output to a plurality of active light emitting diodes (LEDs) or other current driven load are disclosed and, more particularly, a device and method for controlling current to a plurality of active LEDs that are disposed in series at the output of a corresponding plurality of isolation transformers by controlling a single current.

Safety considerations require isolating an AC line from LEDs when the LEDs are used for lighting purposes. Ideally, series connected LEDs should be driven using a single current source. However, if a large number of LEDS is connected in series, the total voltage across the LEDs may reach dangerous levels.

Conventionally, referring to FIG. 1, when using plural low-voltage LED strings 15 for lighting purposes, an isolated DC-DC converter 14 is disposed between the rectified AC source 10 and the LED strings 15 to produce an isolated low-voltage output 13 (typically 48 V or less).

The output voltage 11 of converter 14 provides power to a plurality of buck regulators 16, which share a common current reference 18. Each buck regulator 16 is structured and arranged to regulate the current in the LED string 15 to a value that is proportional to the current reference 18. Providing individual buck regulators 16 for each LED string 15, however, increases the cost and the size of the device.

Accordingly, it would be desirable to provide a driver and controller for the same, respectively, for powering and driving a plurality of LEDs that are electrically connected in series in a string or an array that does not require individual buck regulators for each string or array.

Furthermore, it would be desirable to be able to isolate the LEDs from an AC source and to control the current to any number of LEDs and to any number of LED strings by controlling the current of a single converter.

It would also be desirable to provide a driver and controller for the same that can also effect color, e.g., red-green-blue (RGB), control and are selectively dimmable by pulse width modulation (PWM).

### BRIEF SUMMARY OF THE INVENTION

A device and method for controlling current output to current driven loads such as active light emitting diodes (LEDs) are disclosed. The device is structured and arranged to control current to an array of plural active LED strings. The device is adapted to generate a single square wave AC current that flows through the primary windings of plural isolation transformers whose primary windings are electrically connected in series. The current flowing through the primary windings induce a current proportional to a reference in secondary windings.

The device includes a current regulator that produces a regulated DC current that is proportional to a current reference; a free running inverter that converts the DC current to square wave AC current; and plural isolation transformers whose secondary windings are electrically connected to LED strings.

### BRIEF DESCRIPTION OF THE SEVERAL VIEWS OF THE DRAWINGS

The foregoing and other objects, features, and advantages of the invention will be apparent from the following Detailed Description of the Invention in conjunction with the Drawings of which:

FIG. 1 shows a device for driving a plurality of low-voltage LED strings in accordance with the prior art;

FIG. 2 shows a device for driving a plurality of low-voltage LED strings in accordance with the present invention;

FIG. 3A shows a current regulator for the device shown in FIG. 2;

FIG. 3B shows an optional control loop for the current regulator shown in FIG. 3B;

FIG. 4 shows a device having synchronous rectification in accordance with the present invention;

FIG. 5 shows the device of FIG. 4 having the added capability of PWM regulation of the current in the LED strings;

FIG. 6 shows an alternative embodiment of the present invention in which synchronous rectifiers are also used to perform PWM modulation of the current in the LED strings;

FIG. 7 shows isolation transformers having non-identical windings turns ratios; and

FIG. 8 shows an AC implementation of the present invention having anti-parallel connected LED strings and RGB color control.

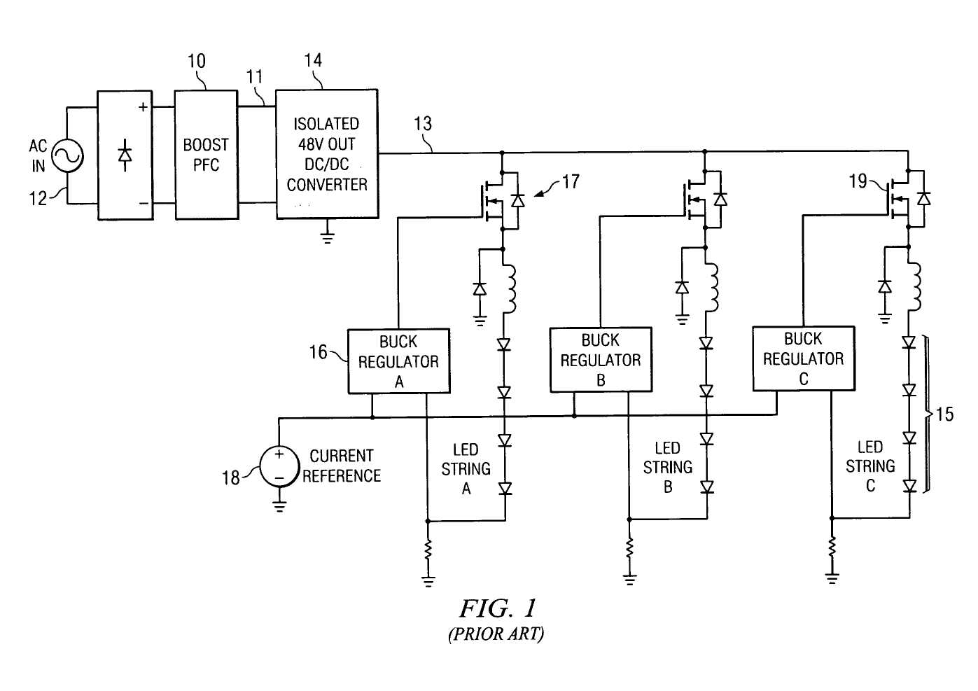

### DETAILED DESCRIPTION OF THE INVENTION

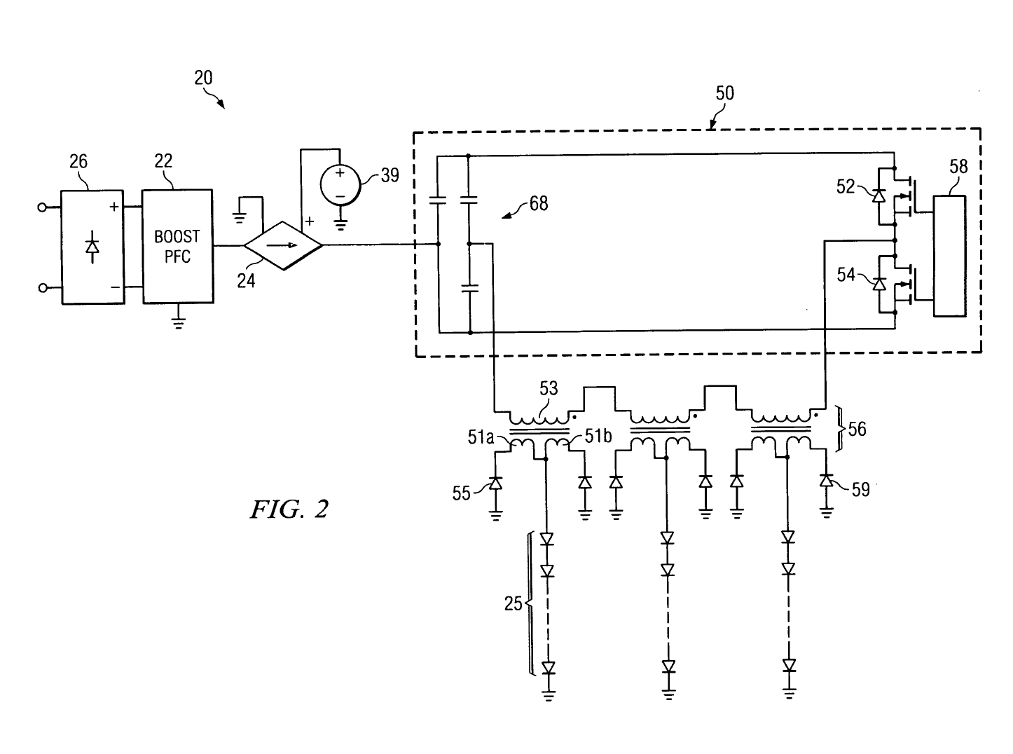

Circuits and methods for controlling current to current driven loads and, more specifically, circuits and methods for isolating, dimming, and controlling an array of plural light emitting diodes (LEDs) that are electrically connected in series are disclosed. Referring to FIG. 2, an AC line voltage is rectified by a rectifier circuit 26. If required, the rectifier circuit 26 can also include a power factor correction (PFC) circuit 22 that is adapted to improve the power factor of the system 20 and to produce a regulated DC voltage.

The output voltage of the rectifier circuit 26 or the PFC circuit 22 feeds a nonisolated current regulator 24 that is structured and arranged to produce a regulated DC current that is proportional to a current reference 39. The regulated DC current is applied to a free running inverter 50 that converts it to a square wave AC current.

Inverter 50 includes a drive circuit 58, plural switching devices 52 and 54, and a filter 68. Although inverter 50 can be implemented using many different topologies, double ended circuits such as half bridges (as shown) and full bridges are preferred because of their ability to perform zero voltage switching (ZVS) and their ability to generate near perfect square wave currents in all components. The invention, however, is not to be construed as being limited to half bridges or full bridges.

The drive circuit 58 is structured and arranged to drive the gates of the switching devices 52 and 54 with out of phase, duty cycle signals that, preferably, are separated by delays consistent with enabling ZVS in the switching devices 52 and 54, to provide a square wave AC current to a plurality of isolation transformers 56. The inverting operation of driving device 58 and switching devices 52 and 54 is well known and will not be described further. Because the buck current regulator 24 rejects low frequency ripple, minimal filtration of the current is required at the input of the inverter 50. For illustrative purposes only, the input filter of the inverter 50 is shown as an array of capacitive elements 68.

The square wave AC current produced by inverter 50 drives a chain of isolation transformers 56 whose primaries 53 are connected in series. The current induced in the secondary windings 51a and 51b of the isolation transformers 56 is rectified by rectifiers 55 and 59 and applied to the load, e.g., a plurality of LEDs in a string 25. Since the currents in each of the primaries 53 of the transformers 56 are equal, the currents induced in the secondaries 51a and 51b and delivered to the LED strings 25 will also be equal or substantially equal. A small error may be caused by differences in magnetizing inductances and the voltages across the LED strings 25. However, as the magnetizing currents will typically be more than an order of magnitude lower than the current in the LED strings 25, a 10% variance in the magnetizing inductances will result in a less than 1% variance in the LED string 25 currents.

Because the current regulator 24 controls the current to all of the LED strings 25 in the system 20, it can also be conveniently used to provide power width modulation (PWM) dimming of all the LED strings 25. This can be readily accomplished by turning the current regulator 24 ON and OFF at a frequency lower than its switching frequency and at the duty cycle required to provide the desired dimming effect. PWM dimming of all of the LEDs in a string 25 can be accomplished by periodically deactivating and reactivating the buck current regulator 24 at a desired PWM frequency. The dimming range is determined by the ratio of the switching frequency of the buck current regulator 24 to the PWM dimming frequency. As a result, the dimming range can be relatively wide.

The current regulator 24 can be realized using various topologies and control methods, e.g., step up converters, fixed output voltage PFC converters, tracking PFC converters, and the like. In a preferred embodiment, the current regulator 24 is a buck regulator operating in Transition Mode (TM), which is to say, operating at the boundary between continuous and discontinuous conduction. The operation of the TM buck regulator 24, although well known, will be briefly described here.

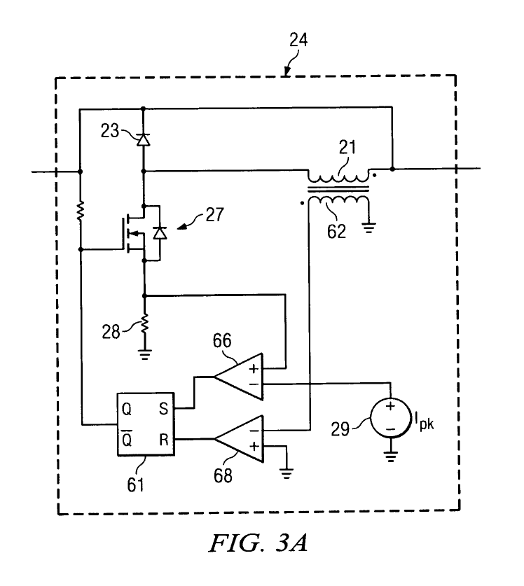

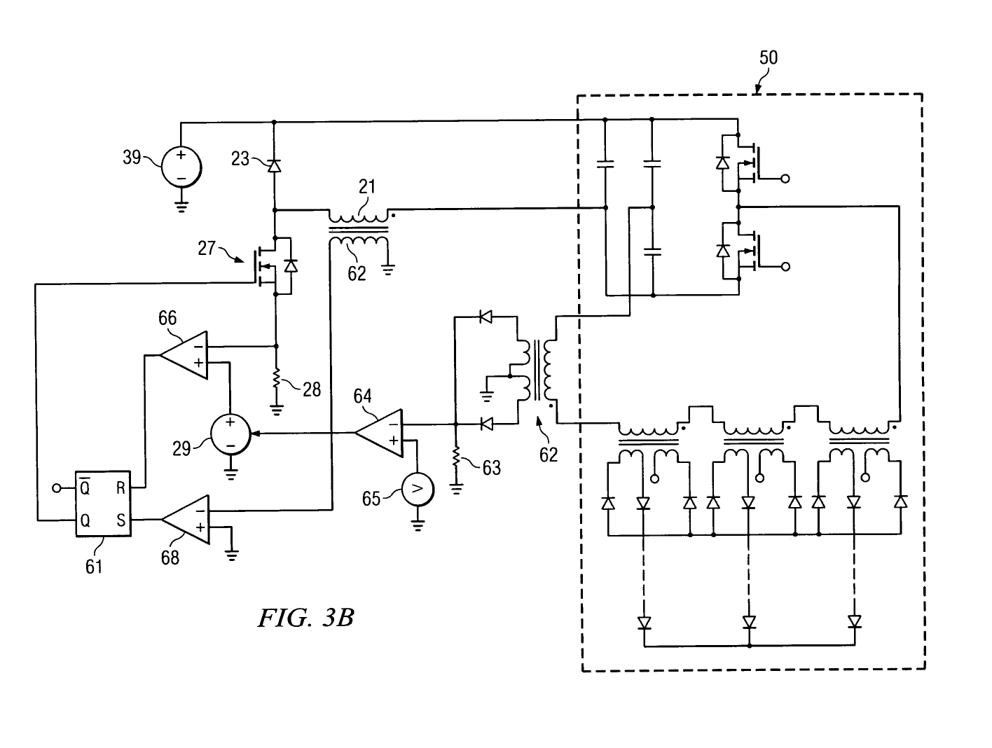

Referring to FIG. 3A, the buck regulator 24 is powered by voltage source 39 and comprises switching device 27, inductor 21 and free wheeling diode 23. The buck regulator 24 delivers current to a load, e.g., the free running inverter 50 of the system 20.

The operation of the buck regulator 24 is controlled by comparators 66 and 68 and a sequential circuit, such as an SR latch 61. Assuming that the regulator 24 starts with the latch 61 in a “set” state, switching device 27 will be ON and the current in inductor 21 will increase linearly until the voltage across a current sense resistor 28 equals the voltage of reference 29, causing comparator 66 to change state and the “reset” latch 61 turns switching device 27 OFF. As a result, the current in the inductor 21 will reach a maximum current value Ipk. Alternatively instead of a sense resistor 28, the current can be sensed by measuring the voltage drop across a cascode drive transistor (not shown).

When the switching device 27 turns OFF, current in inductor 21 will switch from the switching device 27 to the free wheeling diode 23 and will start decreasing. When the current in inductor 21 reaches zero, the voltage across the sense winding 62 will also cross zero, causing comparator 68 to change state, setting latch 61 and turning switching device 27 ON again.

As this cycle repeats, a triangular current waveform that oscillates between zero and Ipk will flow in inductor 27. Accordingly, the regulator 24 will deliver an average current equal to Ipk/2 independently of changes in the voltage of source 39 or the voltage across output load.

The current delivered to the load can be amplitude modulated (AM) by changing the value of reference 29 or through pulse width modulated (PWM), by which the operation of the regulator 24 is successively stopped and restarted at a frequency that is lower than its natural oscillation frequency. Pulse width modulation is well known to the art and will not be described further.

The use of a TM Buck regulator 24 as a current source offers a number of significant advantages. First, as the load current is indirectly regulated, the need to directly sense the output current is eliminated. Second, the hysteretic control is inherently stable, so the circuit design is simplified. Third, due to its cycle by cycle response capability, the regulator 24 is able to reject fast transients in the input voltage 39, providing excellent protection for the sensitive LED loads 25. Fourth, Transition Mode operation eliminates reverse recovery in the free wheeling diode 23 and the losses associated with it, thereby allowing the use of inexpensive, relatively slow diodes with lower forward voltage, yielding better efficiency and lower cost for the system 20. Moreover, the device 20 can drive large number of LED strings 25 from a high AC voltage source. The benefits of such a device 20 include off line operation with low voltage isolated outputs, high efficiency, high power density, and low cost.

Switching devices 27, however, cannot be turned OFF instantaneously. Indeed, the turn off delay will cause an overshoot in the inductor peak current, resulting in an error in the value of the output current. This error may be small enough for many applications, but if the error has to be significantly reduced, an additional control loop can be added. Referring to FIG. 3B, the AC square wave produced by the free running inverter 50 is sensed by the current transformer 62 and rectified, creating a voltage across resistor 63 that is compared to a reference 65 by an error amplifier 64. The output of the error amplifier 64 adjusts the value of reference 29, thereby minimizing the error in the current supply to the LED strings 25.

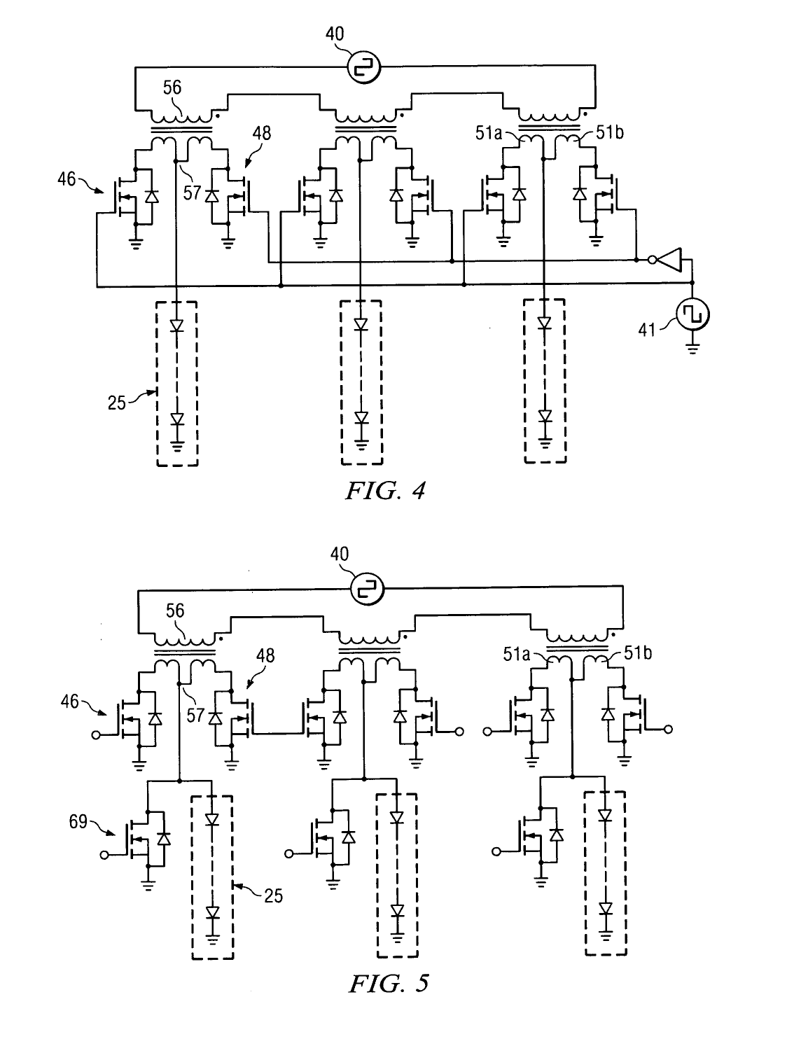

The efficiency of the system 20 can be further improved by using synchronous rectification. Referring to FIG. 4, square wave current source 40 represents the output generated by the previously described current regulator 24 and free running inverter 50. The current induced in the secondaries 51a and 51b of the transformers 56 is rectified by switching devices 46 and 48 instead of by rectifiers 55 and 59 (FIG. 2). The switching devices 46 and 48, which are shown as MOSFETs for illustrative purposes only, are selectively driven by a rectifying controller 41. Various techniques for driving synchronous rectifiers are well known and will not be further discussed here. Ideally, synchronous rectification of the LED strings 25 occurs concurrently with the transition of the DC inverter 50 and for short integrals.

Optionally, an additional degree of control can be added by adapting the system 20 to allow PWM control of the currents in the individual LED strings 25. Because transformers 56 are current driven, PWM control of each of the currents induced and transmitted to the LED strings 25 can be provided by periodically shorting an LED string 25 with a switching device 69 that is driven by a PWM signal. Referring to FIG. 5, switching device 69 is turned ON and OFF by a PWM signal, which periodically shorts LEDs string 25 and thereby provides PWM modulation of the LEDs string current. Switching devices 69 added in parallel with the other LED strings 25 can be driven by a common PWM signal if currents in all LEDs 25 should be equal.

Alternatively, independently variable PWM signals transmitted to each switching device 25 can also be used if the currents and the LED strings 25 are to be controlled independently. This independent control of the LEDs string 46 and 48 currents can be useful in color synthesis and other applications. In cases where synchronous rectification is used, the synchronous rectifiers could also be used to perform the PWM modulation of the LED currents. RGB control and color synthesis can be accomplished by selectively shorting any of the LED strings 25 in the array, to produce a desired color.

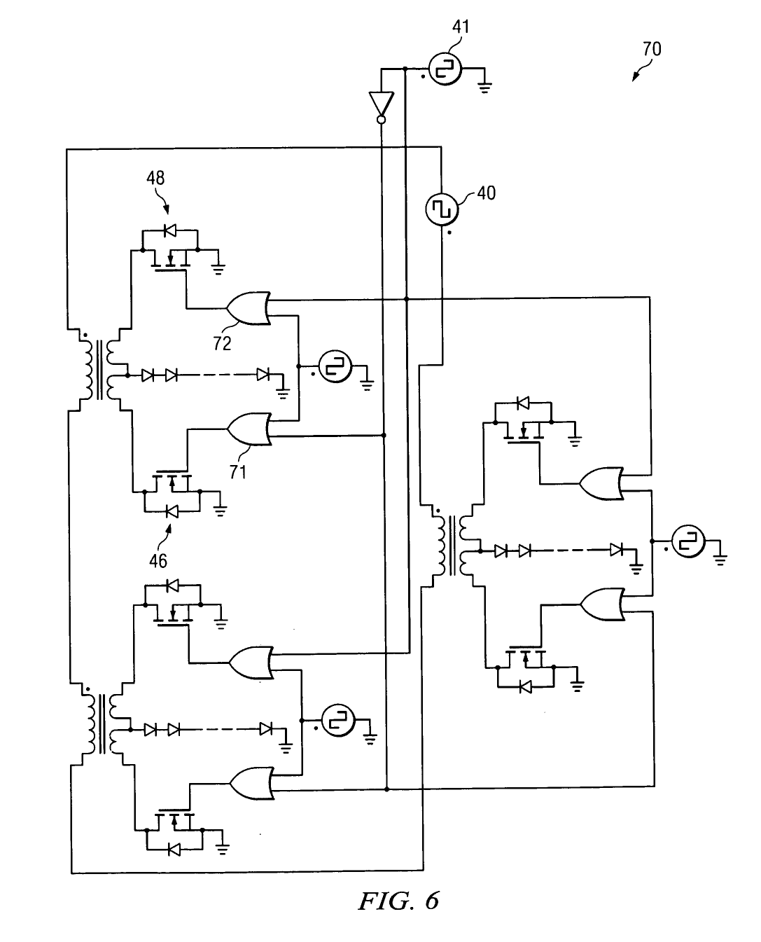

For example, referring to FIG. 6, PWM signals generated by a signal source 41 can be applied through logic OR gates 71 and 72 to the synchronous rectifiers' drive signal, to periodically cause both synchronous rectifiers 46 and 48 to be ON simultaneously, thereby shorting the transformers 56 and the LED strings 25. This implementation is advantageous because it eliminates the need for the previously described shorting switching devices 69 unless conventional rectification is required.

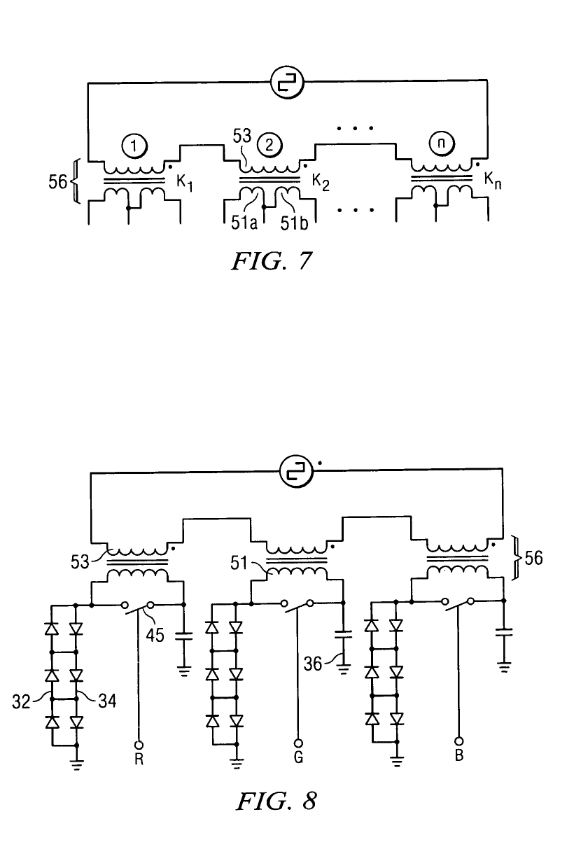

The present invention offers an additional degree of flexibility in design of LEDs systems. Referring to FIG. 7, the series connected primaries 53 of isolation transformers 1, 2 thru n can be designed with different primary to secondary turns ratios, K1, K2, . . . Kn. As a result, LED strings 25 or other loads can be driven separately or independently with currents that have been set to any desirable relative ratio. This capability can be very useful in generating different colors or providing color correction capability.

Another attribute of the present invention is the capability of driving LED strings 25 using AC current rather than DC current. Referring to FIG. 8, LEDs strings 35 formed by connecting LEDs 32 in anti-parallel with LEDs 34 across the secondaries 51 of transformers 56 are shown. Also shown is a capacitive element 36 that is adapted to absorb any voltage drop difference across the windings 53 and 51, which ensures that no DC voltage appears across the transformer 56. Moreover, the addition of a capacitive element 36 permits use of an odd number of LEDs in one direction 32 and even number of LEDs (not shown) in the other direction 34, which can reduce the number of LEDs in and LED string 35. A bi-directional switch 45 can be between the capacitive element 36 and the anti parallel first 32 and second pluralities of light emitting diodes 34. The bi-directional switch 45 is selectively controllable to provide pulse width modulation control of current to the anti parallel first plurality of light emitting diodes 32 and second plurality of light emitting diodes 34.

As a result, current induced in the secondaries 51 flows through LEDs 32 during one half of the square wave cycle and through LEDs 34 during the other half of the square wave cycle Typically, in order to get roughly the same luminous flux output, the AC driven LED strings 25 must be driven with a current having an amplitude of twice the amplitude of the current used for DC drive. However, advantageously, AC drive eliminates the need for rectification in the secondary 51 of the transformers 56. Because the voltage developing across the LEDs string 25 is approximately half the value of the voltage appearing across an equivalent LED strings 25 driven with DC current and, consequently, the total number of transformers 56 used in the AC drive case can be reduced by a factor of two. It follows from the above that the AC drive method has the potential to improve the electrical efficiency, reduce cost, and increase the power density of the driver.

It must emphasized that the use of the present invention is not limited only to LED loads, but it can be also very useful in driving other current driven loads, such as batteries and other similar devices.

It will be apparent to those of ordinary skill in the art that modifications to and variations of the above-described system and method may be made without departing from the inventive concepts described herein. Accordingly, the invention should not be controlled except by the scope and spirit of the appended claims.

What I claim is:

1. A device for controlling or driving a plurality of current driven loads, the device comprising:
a current regulator that is adapted to generate a regulated DC current proportional to a current reference;
a free running inverter that is structured and arranged to convert the regulated DC current to a square wave AC current; and
a plurality of isolation transformers, each transformer having primary windings, secondary windings, and a primary-to-secondary windings turns ratio, wherein the primary windings of each transformer are electrically connected in series and wherein the secondary windings of each transformer are electrically connected to a respective current driven load,
wherein the current regulator is adapted to provide an equal or substantially equal current to the respective current driven load of each transformer.

2. The device as recited in claim 1, wherein the current driven loads comprises an array of light emitting diodes that are electrically connected in series in a light emitting diode string.

3. The device as recited in claim 1 further comprising a rectifying circuit for rectifying an AC line voltage.

4. The device as recited in claim 3, wherein the rectifying circuit includes a power factor correction circuit that is adapted to generate a regulated DC voltage.

5. The device as recited in claim 1, wherein the current regulator is a buck current regulator.

6. The device as recited in claim 5, wherein the buck current regulator is nonisolated and is operated in transition mode at a boundary between continuous conduction and discontinuous conduction.

7. The device as recited in claim 1, wherein the free running inverter includes:
plural switching devices; and
drive circuitry that is structured and arranged to drive said plural switching devices using out of phase duty cycle signals.

8. The device as recited in claim 7, wherein the out of phase duty cycle signals are separated by time delays, to enable zero voltage switching.

9. The device as recited in claim 1, wherein the inverter is structured and arranged as a half bridge inverter or a full bridge inverter and is adapted to perform zero voltage switching.

10. The device as recited in claim 1, wherein each of the plurality of current driven loads includes a first plurality of light emitting diodes that is electrically connected in anti parallel to a second plurality of light emitting diodes.

11. The device as recited in claim 1, further comprising a rectification device in the secondary windings of each isolation transformer.

12. The device as recited in claim 1, wherein the respective primary-to-secondary windings turns ratios of said plurality of isolation transformers differ to generate non-equal currents to their respective current driven loads.

13. The device as recited in claim 1, further comprising switching devices that are electrically connected to the secondary windings of each isolation transformer and that are selectively driven to provide synchronous rectification.

14. The device as recited in claim 1, further comprising switching devices that are electrically connected in parallel with the respective load for shorting said respective loads.

15. The device as recited in claim 14, further comprising a pulse width modulation (PWM) controller that is adapted to generate a PWM signal to control current to the respective load.

16. The device as recited in claim 1, wherein the current regulator is adapted to provide pulse width modulation control of the plurality of current driven loads.

17. The device as recited in claim 11, the device further comprising a capacitive element that is electrically connected in series to the anti parallel first plurality of light emitting diodes and second plurality of light emitting diodes, to absorb voltage imbalances between said anti parallel first plurality of light emitting diodes and second plurality of light emitting diodes.

18. The device as recited in claim 11, the device further comprising:
a bi-directional switching device that is structured and arranged in parallel with the secondary windings, wherein the switching device is selectively controllable to provide pulse width modulation control of current to said anti parallel first plurality of light emitting diodes and second plurality of light emitting diodes.

19. The device as recited in claim 18, wherein the power width modulation control provides color management.

20. A method for controlling current to a plurality of current driven loads comprising:
generating a regulated DC current that is proportional to a current reference;
converting the regulated DC current to a square wave AC current;
driving a plurality of isolation transformers, each transformer having primary windings that are electrically connected in series and secondary windings that are electrically connected to one of the plurality of current driven loads, using the square wave AC current;
inducing current having a magnitude in the secondary windings of each of the plurality of isolation transformers, wherein the magnitude of the current induced in the secondary windings is related to the square wave AC current by a fixed ratio, to power each of the plurality of current driven loads.

21. The method as recited in claim 20 further comprising performing zero voltage switching when converting the regulated DC current to a square wave AC current.

22. The method as recited in claim 20 further comprising performing power factor correction to produce the regulated DC voltage.

23. The method as recited in claim 20 wherein converting the regulated DC current to a square wave AC current includes separating out of phase drive cycle signals that are applied to a pair of switching devices by time delays to enable zero voltage switching.

24. The method as recited in claim 20 further comprising rectifying the current induced in the secondary windings.

25. The method as recited in claim 20, wherein generating is performed using a current regulator, further comprising alternately enabling and disabling the current regulator at a frequency lower than a switching frequency, to provide pulse width modulation dimming.

26. The method as recited in claim 20, wherein generating is performed using a buck current regulator.

27. The method as recited in claim 26, wherein the buck current regulator is operated in transition mode.

28. The method as recited in claim 20 further comprising performing synchronous rectification on the currents induced in the secondary windings of the plurality of isolation transformers.

29. The method as recited in claim 20 further comprising:
generating a pulse width modulation signal; and
applying the pulse width modulation signal to at least one switching device, each of which is electrically connected in parallel with the respective LED string, to control current to each current driven load.

30. The method as recited in claim 29, wherein the pulse width modulation signal is adapted to short at least one of the plurality of isolation transformers.

31. The method as recited in claim 20, wherein each of the plurality of isolation transformers has a primary to secondary windings turns ratio, the method further comprising:
providing different primary to secondary windings turns ratios at each isolation transformer to induce unequal secondary currents.

32. A device for isolating, dimming, and controlling an array of light emitting diodes current that are structured and arranged in plural light emitting diode strings by controlling current to each of the plural light emitting diode strings, the system comprising:
a current regulator that is adapted to generate a regulated DC current proportional to a current reference;
a free running inverter that is structured and arranged to convert the regulated DC current to a square wave AC current; and
a plurality of isolation transformers, each transformer having primary windings, secondary windings, and a primary-to-secondary windings turns ratio, wherein the primary windings of each transformer are electrically connected in series and wherein the secondary windings of each transformer are electrically connected to a respective light emitting diode string,
wherein the current regulator is adapted to provide an equal or substantially equal current to the respective current driven load of each transformer.

33. The device as recited in claim 13, wherein each of the switching devices is driven by at least one of a first gate driving device for providing synchronous rectification and a second gate driving device for simultaneously shorting each of the switching devices and the secondary windings, to provide pulse width modulation of the plurality of light emitting diode strings.
